(19) United States
(12) Patent Application Publication
(10) Pub. No.: US 2026/0059226 A1
(43) Pub. Date: Feb. 26, 2026

(54) ELECTRONIC DEVICE COMPRISING SPEAKER

(71) Applicant: Samsung Electronics Co., Ltd., Suwon-si, (KR)

(72) Inventors: Junwoo CHA, Suwon-si (KR); Yeongjun KIM, Suwon-si (KR); Kijung KIM, Suwon-si (KR); Bosung KIM, Suwon-si (KR); Seonmi KIM, Suwon-si (KR); Kyoungho BANG, Suwon-si (KR); Jaeseong LEE, Suwon-si (KR)

(21) Appl. No.: 19/376,180

(22) Filed: Oct. 31, 2025

Related U.S. Application Data
(63) Continuation of application No. PCT/KR2024/002924, filed on Mar. 7, 2024.

(30) Foreign Application Priority Data
May 16, 2023 (KR) 10-2023-0062945
May 26, 2023 (KR) 10-2023-0068424

(51) Int. Cl. H04R 1/24; H04R 1/08; H04R 1/10

(52) U.S. Cl. CPC H04R 1/24; H04R 1/08; H04R 1/1016; H04R 1/1075; H04R 2201/107; H04R 2460/11

(57) ABSTRACT

An electronic device is provided. The electronic device includes at least one speaker including a first surface, a second surface opposite to the first surface, and a side surface connecting the first surface and the second surface, a housing accommodating the at least one speaker, the housing including a first audio path extending from the first surface toward an exterior of the electronic device such that audio from the first surface is emitted to the exterior of the electronic device, and a vent hole separated from the first audio path, a guide part extending along at least a portion of the side surface within the housing, the guide part including a first portion contacting the housing, and a second portion spaced apart from the housing by a gap, and a second audio path extending from the gap to the vent hole such that audio from the second surface passing through the gap is emitted to the vent hole, wherein the second audio path is located between the housing and an outer surface of the guide part opposite to an inner surface of the guide part facing at least a portion of the side surface.

### CROSS-REFERENCE TO RELATED APPLICATION(S)

This application is a continuation application, claiming priority under 35 U.S.C. § 365(c), of an International application No. PCT/KR2024/002924, filed on Mar. 7, 2024, which is based on and claims the benefit of a Korean patent application number 10-2023-0062945, filed on May 16, 2023, in the Korean Intellectual Property Office, and of a Korean patent application number 10-2023-0068424, filed on May 26, 2023, in the Korean Intellectual Property Office, the disclosure of each of which is incorporated by reference herein in its entirety.

### BACKGROUND

### 1. Field

The disclosure relates to an electronic device including a speaker.

### 2. Description of Related Art

An electronic device may include various electric components to meet a demand of a user. For example, the electronic device may include a speaker configured to emit audio to provide audible information to the user. The electronic device may include an audio path capable of guiding movement of the audio outputted from the speaker to an exterior of the electronic device. The audio outputted from the speaker may be transmitted from the speaker in the electronic device to the exterior of the electronic device by moving along the audio path.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device including a speaker.

Additional aspects will be set forth in part in the description which follows and, in part, will be apparent from the description, or may be learned by practice of the presented embodiments.

In accordance with an aspect of the disclosure, an electronic device is provided. The electronic device includes at least one speaker including a first surface, a second surface opposite to the first surface, and a side surface connecting the first surface and the second surface, a housing accommodating the at least one speaker, the housing including a first audio path extending from the first surface toward an exterior of the electronic device such that audio from the first surface is emitted to the exterior of the electronic device, and a vent hole separated from the first audio path, a guide part extending along at least a portion of the side surface within the housing, the guide part including a first portion contacting the housing, and a second portion spaced apart from the housing by a gap, and a second audio path extending from the gap to the vent hole such that audio from the second surface passing through the gap is emitted to the vent hole, wherein the second audio path is located between the housing and an outer surface of the guide part opposite to an inner surface of the guide part facing at least a portion of the side surface.

In accordance with another aspect of the disclosure, an electronic device is provided. The electronic device includes a housing including a vent hole, and a nozzle part configured to be inserted into an ear canal of a user when the electronic device is worn by the user, at least one speaker including a first surface facing the nozzle part, a second surface opposite to the first surface, and a side surface connecting the first surface and the second surface, an electric component disposed on the second surface and spaced apart from the at least one speaker, and a bracket including a flange part disposed between the at least one speaker and the electric component, and a guide part connected to the flange part and extending along at least a portion of the side surface within the housing, wherein the guide part includes a first portion contacting the housing, and a second portion spaced apart from the housing by a gap, and wherein audio from the second surface is emitted to the vent hole by passing the gap along an audio path located between the housing and an outer surface of the guide part opposite to an inner surface of the guide part facing at least a portion of the side surface.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is an exploded perspective view of an electronic device according to an embodiment of the disclosure;

FIG. 1B illustrates a state in which an electronic device is worn by a user according to an embodiment of the disclosure;

FIG. 2A is a perspective view of an electronic device according to an embodiment of the disclosure;

FIG. 2B is a cross-sectional view illustrating an example in which an electronic device is cut along line A-A′ of FIG. 2A according to an embodiment of the disclosure;

FIG. 2C is a cross-sectional view illustrating an example in which an electronic device is cut along line B-B′ of FIG. 2A according to an embodiment of the disclosure;

FIG. 3A is a perspective view of an electronic device according to an embodiment of the disclosure; and

FIG. 3B is a cross-sectional view illustrating an example in which an electronic device is cut along line C-C′ of FIG. 3A according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface”includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi™) chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

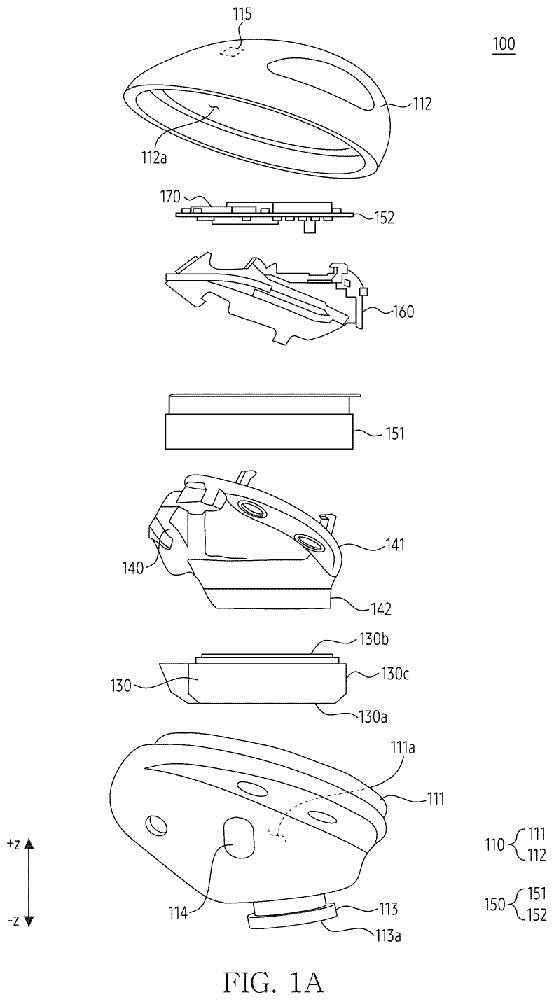

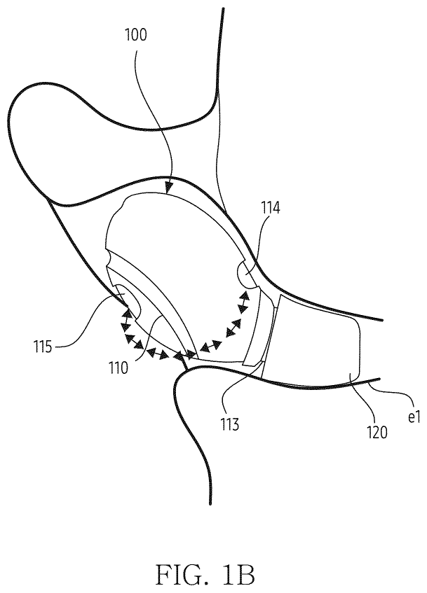

FIG. 1A is an exploded perspective view of an electronic device according to an embodiment of the disclosure, and FIG. 1B illustrates a state in which an electronic device is worn by a user according to an embodiment of the disclosure.

Referring to FIGS. 1A and 1B, according to an embodiment, an electronic device 100 may include a housing 110, an ear tip 120, at least one speaker 130, a first bracket 140, an electric component 150, a second bracket 160, and/or at least one microphone 170. For example, the electronic device 100 may be worn on an ear of the user. For example, the electronic device 100 may be referred to as a wearable device. The electronic device 100 may be configured to provide audio information to the user based on emitting audio through the at least one speaker 130. For example, the electronic device 100 may output (or emit) audio corresponding to a signal through the at least one speaker 130 based on receiving the signal from another electronic device outside the electronic device 100. For example, the electronic device 100 may be connected to the other electronic device outside the electronic device 100 through a wireless communication method (e.g., Bluetooth™), but is not limited thereto. For example, since the electronic device 100 may provide the audio information, it may be referred to as an earphone. For example, in a case that the electronic device 100 is connected to the other electronic device through the wireless communication method, the electronic device 100 may be referred to as a wireless earphone. The electronic device 100 may obtain another signal corresponding to sound based on receiving the sound from the outside of the electronic device 100 through the at least one microphone 170. The electronic device 100 may output (or emit) another audio corresponding to the other signal through the at least one speaker 130 based on obtaining the other signal. For example, the at least one microphone 170 may be used to obtain information on an environment of the outside of the electronic device 100, but is not limited thereto.

According to an embodiment, the housing 110 may define (or form) an outer surface of the electronic device 100. In a case that the electronic device 100 is worn by the user, the housing 110 may contact a part (e.g., an ear) of a body of the user. The housing 110 may provide a space in which at least a portion of components of the electronic device 100 may be accommodated (or disposed). The housing 110 may enclose (or surround) the at least a portion of components of the electronic device 100. For example, the at least one speaker 130, the first bracket 140, the electric component 150, the second bracket 160, and/or the at least one microphone 170 may be accommodated (or disposed) in the housing 110. According to an embodiment, the housing 110 may include a first case 111, a second case 112, a nozzle part 113, a vent hole 114, and/or a microphone hole 115.

According to an embodiment, the first case 111 may form (or define) a portion of the outer surface of the electronic device 100. The first case 111 may form (or define) a first space 111a of the housing 110. For example, the first case 111 may surround (or enclose) the first space 111a. The first case 111 may accommodate a portion of the components of the electronic device 100. For example, the at least one speaker 130 and a portion of the first bracket 140 may be disposed (or accommodated) in the first case 111.

According to an embodiment, the second case 112 may form (or define) another portion of the outer surface of the electronic device 100. The second case 112 may form (or define) a second space 112a of the housing 110. For example, the second case 112 may surround (or enclose) the second space 112a. The second case 112 may accommodate another portion of the components of the electronic device 100. For example, another portion of the first bracket 140, the electric component 150, the second bracket 160, and/or the at least one microphone 170 may be disposed (or accommodated) in the second case 112. According to an embodiment, the second case 112 may be coupled to the first case 111. For example, the second case 112 may be manufactured separately from the first case 111 and then coupled to the first case 111. For example, the second case 112 may be coupled to the first case 111 through a snap-fit method, but is not limited thereto.

According to an embodiment, the nozzle part 113 may provide a passage through which the audio from the at least one speaker 130 may be emitted to an exterior of the housing 110. The nozzle part 113 may define (or form) a first audio path 113a. For example, the nozzle part 113 may surround (or enclose) the first audio path 113a. The first audio path 113a may extend from the at least one speaker 130 toward the exterior of the electronic device 100 (or the exterior of the housing 110). For example, the first audio path 113a may extend from a first surface 130a of the at least one speaker 130 to the exterior of the electronic device 100 (or the exterior of the housing 110). According to an embodiment, when the electronic device 100 is worn by the user, the nozzle part 113 may be accommodated in an ear canal e1 of the user. For example, when the electronic device 100 is worn by the user, the nozzle part 113 may be inserted into the ear canal e1 of the user. Since the nozzle part 113 is inserted into the ear canal e1 of the user in a state of the electronic device 100 is worn by the user, the electronic device 100 may be referred to as a kernel-type earphone.

According to an embodiment, the vent hole 114 may connect the exterior of the housing 110 and an interior of the housing 110. The vent hole 114 may provide a passage through which sound of the outside of the housing 110 is transmitted to the ear canal e1 of the user when the electronic device 100 is worn by the user. The vent hole 114 may be spaced apart from the first audio path 113a. The vent hole 114 may penetrate the housing 110. For example, the vent hole 114 may penetrate a region of the housing 110 corresponding to a side surface 130c of the at least one speaker 130. For example, the vent hole 114 may be formed (or located) in the region of the housing 110 corresponding to the side surface 130c of the at least one speaker 130.

According to an embodiment, the side surface 130c of the at least one speaker 130 may be disposed between the first surface 130a and a second surface 130b of the at least one speaker 130. The first surface 130a of the at least one speaker 130 may face the nozzle part 113. The first surface 130a of the at least one speaker 130 may contact the first audio path 113a. The second surface 130b of the at least one speaker 130 may be opposite to the first surface 130a of the at least one speaker 130. A direction (e.g., a+z direction) in which the second surface 130b of the at least one speaker 130 faces may be opposite to a direction (e.g., a−z direction) in which the first surface 130a of the at least one speaker 130 faces. The second surface 130b of the at least one speaker 130 may face the first bracket 140. The side surface 130c of the at least one speaker 130 may connect the first surface 130a and the second surface 130b of the at least one speaker 130. For example, the side surface 130c of the at least one speaker 130 may connect a periphery of the first surface 130a and a periphery of the second surface 130b of the at least one speaker 130.

According to an embodiment, the microphone hole 115 may provide a passage through which sound of the outside of the housing 110 may be transmitted to the interior of the housing 110. The sound of the outside of the housing 110 may be transmitted to the interior of the housing 110 by passing through the microphone hole 115. For example, a location of the microphone hole 115 may correspond to a location of the at least one microphone 170 in the housing 110. The microphone hole 115 may penetrate the housing 110. For example, the microphone hole 115 may penetrate the second case 112.

According to an embodiment, when the electronic device 100 is worn by the user, the ear tip 120 may be inserted (or accommodated) into the ear canal e1 of the user. For example, when the electronic device 100 is worn by the user, the ear tip 120 may contact the ear canal e1 of the user. The ear tip 120 may be detachably (or separably) coupled to the housing 110. For example, the ear tip 120 may be detachably (or separably) coupled to the nozzle part 113 of the housing 110. For example, the ear tip 120 may enclose or surround at least a portion of the nozzle part 113 in a state of being coupled to the housing 110. According to an embodiment, when the electronic device 100 is worn by the user, the ear tip 120 may be deformable to correspond to an inner shape of the ear canal e1 of the user. For example, the ear tip 120 may be formed of a material having elasticity.

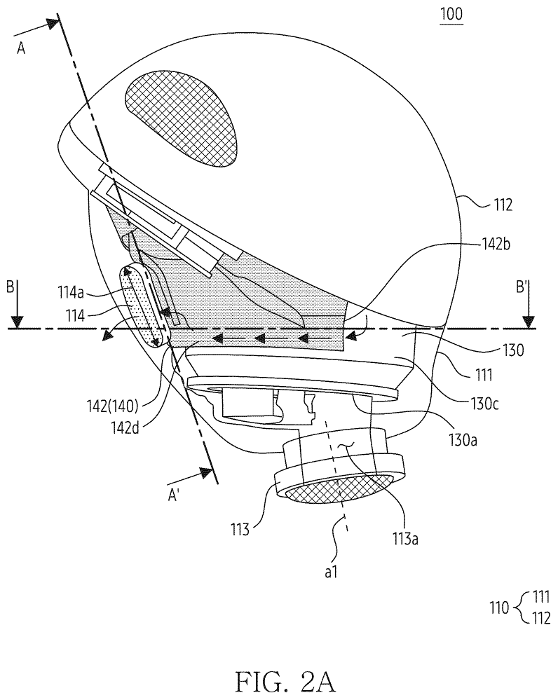

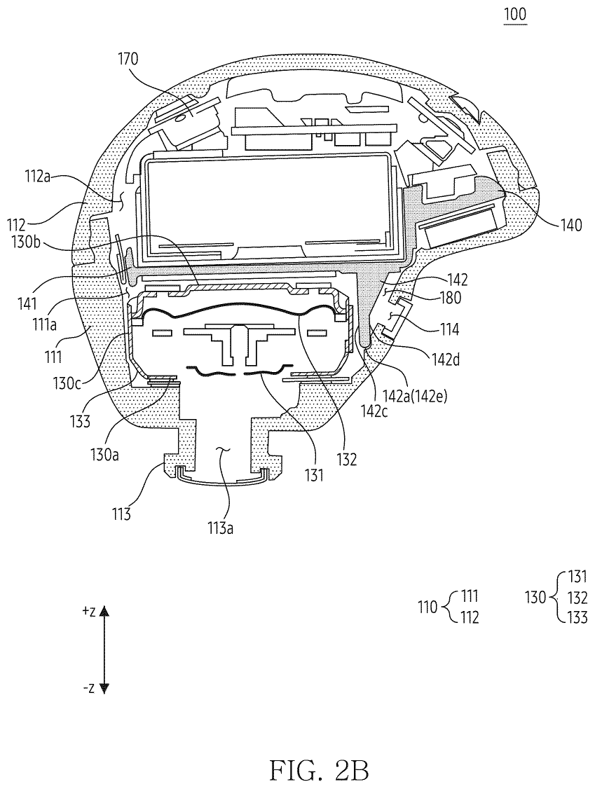

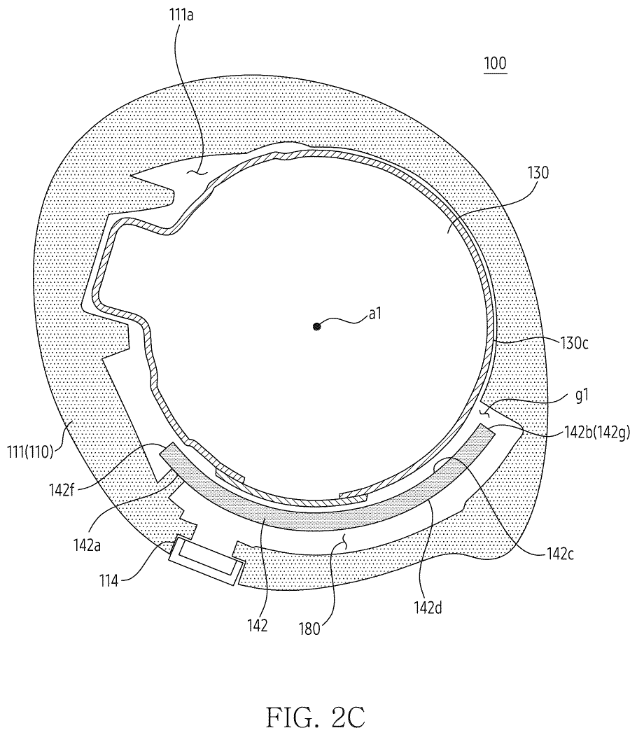

According to an embodiment, the at least one speaker 130 may be configured to emit (or output) audio. The at least one speaker 130 may emit (or output) the audio through at least one of the first surface 130a and the second surface 130b. A first audio may be emitted through the first surface 130a of the at least one speaker 130, and a second audio different from the first audio may be emitted through the second surface 130b of the at least one speaker 130. For example, the second audio may have a frequency lower than the first audio. In a case that the second audio has the frequency lower than the first audio, the first audio may be emitted (or outputted) from a first vibration plate (e.g., a first vibration plate 131 of FIG. 2B) facing the first surface 130a, and the second audio may be emitted (or outputted) from a second vibration plate (e.g., a second vibration plate 132 of FIG. 2B) facing the second surface 130b. For example, the first vibration plate 131 may form a tweeter unit of the at least one speaker 130, and the second vibration plate 132 may form a woofer unit of the at least one speaker 130. For example, the second audio may be referred to as a rear sound. However, it is not limited thereto. For example, the second audio may have a different phase from the first audio. In a case that the second audio and the first audio have different phases, the at least one speaker 130 may include only one vibration plate facing the first surface 130a. The first audio from the first surface 130a of the at least one speaker 130 may be transmitted to the exterior of the housing 110 along the first audio path 113a. The second audio from the second surface 130b of the at least one speaker 130 may pass through the vent hole 114 and be transmitted to the exterior of the housing 110.

According to an embodiment, the first bracket 140 may be disposed between the at least one speaker 130 and the electric component 150. The first bracket 140 may separate the first space 111a and the second space 112a in the housing 110. For example, a portion of the first bracket 140 may be disposed between the first space 111a and the second space 112a. The first bracket 140 may separate the first space 111a in which the at least one speaker 130 is disposed and the second space 112a in which the electric component 150 is disposed, thereby decreasing electrical interference between the at least one speaker 130 and the electric component 150. For example, the first bracket 140 may be formed of a non-conductive material, but is not limited thereto.

According to an embodiment, the first bracket 140 may include a flange part 141 and a guide part 142. The flange part 141 may be disposed on the second surface 130b of the at least one speaker 130. For example, the flange part 141 may cover the second surface 130b of the at least one speaker 130. The guide part 142 may guide the second audio from the second surface 130b of the at least one speaker 130 to move to the exterior of the housing 110. The guide part 142 may be connected to the flange part 141. The guide part 142 may contact the flange part 141. For example, the guide part 142 may be integrally formed with the flange part 141. According to an embodiment, the guide part 142 may be disposed (or may extend) along at least a portion of the side surface 130c of the at least one speaker 130. For example, the guide part 142 may enclose (or surround) the at least a portion of the side surface 130c of the at least one speaker 130. For example, the guide part 142 may overlap the at least a portion of the side surface 130c of the at least one speaker 130 and may not overlap the first surface 130a and the second surface 130b of the at least one speaker 130.

According to an embodiment, the electric component 150 may implement various functions such that the electronic device 100 may provide various functions to the user. For example, the electric component 150 may include a battery 151 and/or a printed circuit board 152. The battery 151 may store power to be provided to the electric component 150 and the at least one speaker 130. According to an embodiment, the battery 151 may be disposed on the first bracket 140. For example, the battery 151 may be disposed on the flange part 141. The printed circuit board 152 may be disposed on the second bracket 160. For example, the printed circuit board 152 may include a processor for controlling an operation of the battery 151 and the at least one speaker 130. For example, the printed circuit board 152 may include communication circuitry for communicating with the other electronic device outside the electronic device 100. However, an example of the electric component 150 is not limited by the above, and the electronic device 100 may further include the other electric components.

According to an embodiment, the second bracket 160 may be disposed between the battery 151 and the printed circuit board 152. As the second bracket 160 is disposed between the battery 151 and the printed circuit board 152, electrical interference between the battery 151 and the printed circuit board 152 may be decreased. For example, the second bracket 160 may be formed of the non-conductive material, but is not limited thereto.

According to an embodiment, the at least one microphone 170 may obtain an electrical signal based on sound from the outside of the housing 110. For example, the at least one microphone 170 may be utilized to obtain a voice of the user. For example, the at least one microphone 170 may be utilized to implement a noise canceling function. According to an embodiment, the at least one microphone 170 may be disposed in the housing 110. For example, the at least one microphone 170 may be disposed in the second case 112. In a case that the at least one microphone 170 is disposed in the second case 112, the at least one microphone 170 may face the microphone hole 115. For example, the at least one microphone 170 may be disposed on the printed circuit board 152. However, it is not limited thereto. For example, the at least one microphone 170 may be disposed in the first case 111.

For example, in a state that the electronic device 100 is worn by the user, the ear tip 120 may be in close contact with the ear canal e1 of the user. In the state that the electronic device 100 is worn by the user, the vent hole 114 and the microphone hole 115 may be located outside the ear canal e1 of the user. In the state that the electronic device 100 is worn by the user, the vent hole 114 and the microphone hole 115 may not be inserted into the ear canal e1 of the user. In a case that the vent hole 114 is not formed, the user may feel uncomfortable since sound outside the ear canal e1 is not transmitted to inside the ear canal e1 as the ear tip 120 is in close contact with the ear canal e1 of the user. As the vent hole 114 is formed, since sound (or air) between the inside of the ear canal e1 and the outside of the ear canal e1 may be moved in a state that the ear tip 120 is in close contact with the ear canal e1, the electronic device 100 may decrease the discomfort of the user. As the at least one speaker 130 operates in the state that the ear tip 120 is in close contact with the ear canal e1 of the user, the first audio from the first surface 130a of the at least one speaker 130 may be transmitted to an eardrum along the ear canal e1 of the user by being released to the exterior of the housing 110. While the first audio is being emitted, the second audio from the second surface 130b of the at least one speaker 130 may be emitted to the exterior of the housing 110 through the vent hole 114 located outside the ear canal e1. The second audio emitted through the vent hole 114 may be received by the at least one microphone 170 through the microphone hole 115 located outside the ear canal e1. In a case that the second audio is received by the at least one microphone 170, howling based on audio feedback may occur, in which the second audio is outputted again through the at least one speaker 130. Hereinafter, a structure of the electronic device 100 for decreasing the howling will be described.

FIG. 2A is a perspective view of an electronic device according to an embodiment of the disclosure, FIG. 2B is a cross-sectional view illustrating an example in which an electronic device is cut along line A-A′ of FIG. 2A according to an embodiment of the disclosure, and FIG. 2C is a cross-sectional view illustrating an example in which an electronic device is cut along line B-B′ of FIG. 2A according to an embodiment of the disclosure.

Referring to FIGS. 2A, 2B, and 2C, according to an embodiment, a flange part 141 may be disposed in a first case 111 and a second case 112 of a housing 110. According to an embodiment, a vent hole 114 may have a shape extending along an axis a1 of the housing 110. For example, a long axis 114a of the vent hole 114 may be substantially parallel to the axis a1 of the housing 110, but is not limited thereto. For example, an angle between the long axis 114a of the vent hole 114 and the axis a1 of the housing 110 may be an acute angle. The axis a1 of the housing 110 may be substantially parallel to a first audio path 113a. The axis a1 of the housing 110 may be substantially parallel to an extending direction of a nozzle part 113. Meanwhile, in FIG. 2A, the vent hole 114 is illustrated in a form with the long axis 114a, but a shape of the vent hole 114 is not limited thereto. For example, the vent hole 114 may have a circular shape and/or a polygonal shape without the long axis 114a.

According to an embodiment, at least one speaker 130 may include a first vibration plate 131, a second vibration plate 132, and/or an enclosure 133. According to an embodiment, the first vibration plate 131 may face a first surface 130a. The first vibration plate 131 may output a first audio toward the first surface 130a. The first audio emitted from the first vibration plate 131 may pass through the nozzle part 113 along the first audio path 113a after passing through the first surface 130a. The first audio may be transmitted to the exterior of the housing 110 after passing through the nozzle part 113.

According to an embodiment, the second vibration plate 132 may face a second surface 130b. The second vibration plate 132 may output a second audio. For example, the second vibration plate 132 may operate (or vibrate) independently of the first vibration plate 131. The second vibration plate 132 may be disposed on the first vibration plate 131. The second audio emitted from the second vibration plate 132 may pass through the second surface 130b. The second audio passing through the second surface 130b may be transmitted to a first space 111a of the housing 110.

According to an embodiment, the enclosure 133 may define (or form) an outer surface of the at least one speaker 130. For example, the enclosure 133 may define (or form) the first surface 130a, the second surface 130b, and/or a side surface 130c, which are the outer surface of the at least one speaker 130. The enclosure 133 may accommodate the first vibration plate 131 and the second vibration plate 132. The enclosure 133 may enclose (or surround) the first vibration plate 131 and the second vibration plate 132. According to an embodiment, the enclosure 133 may include at least one first hole and at least one second hole. The at least one first hole may penetrate the first surface 130a. The at least one first hole may be formed on the first surface 130a. The at least one first hole may provide a passage through which the first audio from the first vibration plate 131 is transmitted to the first audio path 113a. The at least one second hole may penetrate the second surface 130b. The at least one second hole may be formed on the second surface 130b. The at least one second hole may provide a passage through which the second audio from the second vibration plate 132 is transmitted to the first space 111a.

According to an embodiment, a guide part 142 may extend along at least a portion of a circumference of the at least one speaker 130. For example, the guide part 142 may extend within the housing 110 along at least a portion of the side surface 130c of the at least one speaker 130. For example, the guide part 142 may extend between the at least a portion of the side surface 130c of the at least one speaker 130 and the housing 110. For example, when the housing 110 is viewed along a direction (e.g., a−z direction) in which the first surface 130a faces, the guide part 142 may be disposed (or located) between the at least one speaker 130 and the vent hole 114.

According to an embodiment, the guide part 142 may include a first portion 142a and a second portion 142b. The first portion 142a may contact the housing 110. The second portion 142b may be spaced apart from the first portion 142a by a designated distance. For example, the second portion 142b may be spaced apart from the first portion 142a by a designated distance along a circumferential direction of the housing 110. The second portion 142b may be spaced apart from the housing 110. The second portion 142b may be spaced apart from the housing 110 along the circumferential direction of the housing 110. For example, the second portion 142b may be spaced apart from the housing 110 along a circumferential direction of the at least one speaker 130. For example, the second portion 142b may be spaced apart from the housing 110 when facing the housing 110 along the direction (e.g., the −z direction) in which the first surface 130a faces. As the second portion 142b and the housing 110 are spaced apart from each other, a gap g1 may be located (or formed) between the housing 110 and the second portion 142b. The gap g1 may provide a passage through which the second audio transmitted into the first space 111a may pass. The gap g1 may be connected to the first space 111a in the housing 110 in which the at least one speaker 130 is disposed.

According to an embodiment, the guide part 142 may include an inner surface 142c, an outer surface 142d, an attachment surface 142e, a first side surface 142f, and a second side surface 142g. The inner surface 142c may face at least a portion of the side surface 130c of the at least one speaker 130. The inner surface 142c may extend along the at least a portion of the side surface 130c of the at least one speaker 130. The inner surface 142c may surround (or enclose) at least a portion of the first space 111a. The inner surface 142c may face the axis a1 of the housing 110. The outer surface 142d may be opposite to the inner surface 142c. For example, a direction in which the outer surface 142d faces may be opposite to a direction in which the inner surface 142c faces, but is not limited thereto. For example, the outer surface 142d may be spaced apart from the inner surface 142c along a radiation direction of the housing 110. The radiation direction may indicate a direction away from an axis (or a center) of a component, and the corresponding expression may be utilized substantially the same unless otherwise stated. For example, the outer surface 142d may be spaced apart from the inner surface 142c along a radiation direction of the at least one speaker 130. According to an embodiment, the attachment surface 142e may contact the housing 110. The attachment surface 142e may be attached to the housing 110. The attachment surface 142e may face the direction (e.g., the −z direction) in which the first surface 130a faces. For example, the attachment surface 142e may be substantially perpendicular to at least one of the inner surface 142c and the outer surface 142d, but is not limited thereto. The first side surface 142f may be disposed between the inner surface 142c and the outer surface 142d. For example, the first side surface 142f may be disposed between the inner surface 142c and the outer surface 142d when the housing 110 is viewed along the direction (e.g., the −z direction) in which the first surface 130a faces. For example, the first side surface 142f may connect the inner surface 142c and the outer surface 142d when the housing 110 is viewed along the direction (e.g., the −z direction) in which the first surface 130a faces. The second side surface 142g may be disposed between the inner surface 142c and the outer surface 142d. For example, the second side surface 142g may be disposed between the inner surface 142c and the outer surface 142d when the housing 110 is viewed along the direction (e.g., the −z direction) in which the first surface 130a faces. For example, the second side surface 142g may connect the inner surface 142c and the outer surface 142d when the housing 110 is viewed along the direction (e.g., the −z direction) in which the first surface 130a faces. The second side surface 142g may be opposite to the first side surface 142f. For example, a direction in which the second side surface 142g faces may be opposite to a direction in which the first side surface 142f faces. The second side surface 142g may be spaced apart from the first side surface 142f. The second side surface 142g may be located between the gap g1 and the housing 110.

According to an embodiment, a location of the first portion 142a may indicate a location in contact with the housing 110 among locations in the outer surface 142d, the first side surface 142f, and the second side surface 142g of the guide part 142. For example, the location of the first portion 142a may indicate a location in contact with the housing 110 among locations in the outer surface 142d of the guide part 142. However, it is not limited thereto, and the location of the first portion 142a may indicate a location in contact with the housing 110 among locations in the first side surface 142f. According to an embodiment, the second portion 142b may include the second side surface 142g of the guide part 142. For example, a location of the second portion 142b may indicate the second side surface 142g of the guide part 142.

According to an embodiment, an electronic device 100 may include a second audio path 180. The second audio path 180 may be located (or formed) between the guide part 142 and the housing 110. The second audio path 180 may extend (or be formed) along the at least a portion of the side surface 130c of the at least one speaker 130. The second audio path 180 may be located between the outer surface 142d of the guide part 142 and the housing 110. For example, the second audio path 180 may be formed by depressing the outer surface 142d of the guide part 142 inward, but is not limited thereto. The second audio path 180 may be connected to the gap g1 between the second portion 142b and the housing 110. The second audio path 180 may extend from the gap g1 to the vent hole 114 such that the second audio from the second surface 130b passing through the gap g1 is emitted to the vent hole 114. As the second audio path 180 is formed by the guide part 142, a movement path of the second audio from the second surface 130b to the vent hole 114 may be increased. For example, audio transmitted to the first space 111a after passing through the second surface 130b may be transmitted to the vent hole 114 only through the gap g1 since the first portion 142a of the guide part 142 is in contact with the housing 110. Since the second audio is transmitted to the vent hole 114 only through the gap g1, the movement path of the second audio from the second surface 130b to the vent hole 114 may be relatively increased than a case that the guide part 142 is omitted. As the movement path of the second audio is increased, a size of the second audio transmitted to the vent hole 114 may be decreased. As the size of the second audio transmitted to the vent hole 114 is decreased, the size of the second audio received by the at least one microphone 170 after passing through the vent hole 114 may be decreased.

According to an embodiment, the vent hole 114 may be close (or adjacent) to the first portion 142a of the first portion 142a and the second portion 142b. As the vent hole 114 is closer to the first portion 142a in contact with the housing 110, the movement path of the second audio from the second surface 130b to the vent hole 114 may be relatively increased than a case that the vent hole 114 is close to the second portion 142b. As the movement path of the second audio is relatively increased, the size of the second audio received by the at least one microphone 170 after passing through the vent hole 114 may be decreased.

As described above, the electronic device 100 according to an embodiment may provide a structure for decreasing the size of the second audio received by the at least one microphone 170 after passing through the vent hole 114 by the guide part 142 that relatively increases the movement path of the second audio from the second surface 130b to the vent hole 114.

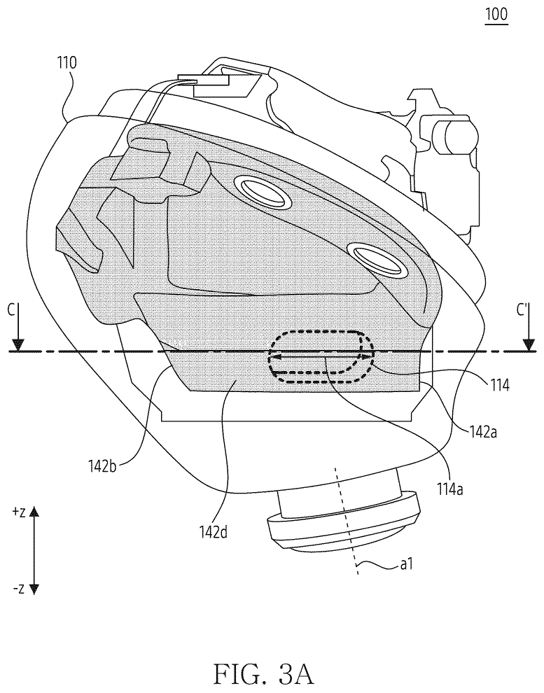

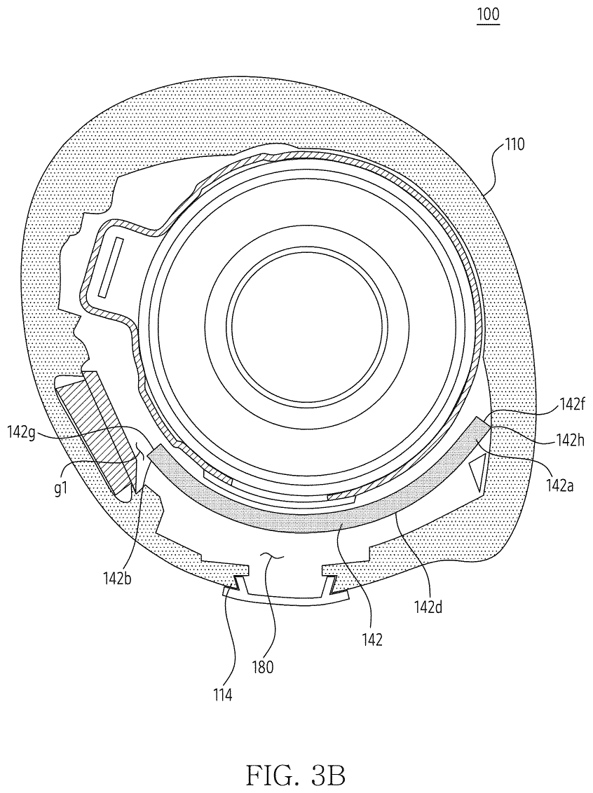

FIG. 3A is a perspective view of an electronic device according to an embodiment of the disclosure, and FIG. 3B is a cross-sectional view illustrating an example in which an electronic device is cut along line C-C′ of FIG. 3A according to an embodiment of the disclosure.

Since the electronic device 100 of FIGS. 3A and 3B may be the electronic device 100 in which a relationship between a vent hole 114 and a guide part 142 and a relationship between the guide part 142 and a housing 110 are changed, a redundant description will be omitted.

Referring to FIGS. 3A and 3B, according to the embodiment, a vent hole 114 may have a shape extending along a direction different from an axis a1 of a housing 110. For example, a long axis 114a of the vent hole 114 may be substantially perpendicular to the axis a1 of the housing 110, but is not limited thereto. For example, an angle between the long axis 114a of the vent hole 114 and the axis a1 of the housing 110 may be an obtuse angle.

According to an embodiment, a location of the first portion 142a of the guide part 142 may include a corner 142h of the guide part 142. For example, the location of the first portion 142a of the guide part 142 may indicate the corner 142h of the guide part 142 where a first side surface 142f and an outer surface 142d are in contact (or connected). According to an embodiment, a second portion 142b may include a second side surface 142g of the guide part 142. For example, a location of the second portion 142b may indicate the second side surface 142g of the guide part 142.

According to an embodiment, a distance between the vent hole 114 and the first portion 142a may be substantially the same as a distance between the vent hole 114 and the second portion 142b. The distance between the vent hole 114 and the first portion 142a may indicate a linear distance from the vent hole 114 to the first portion 142a. The distance between the vent hole 114 and the second portion 142b may indicate a linear distance from the vent hole 114 to the second portion 142b.

As described above, the electronic device 100 according to an embodiment may provide a structure capable of decreasing howling caused by a second audio emitted to the vent hole 114 along a second audio path 180 by the guide part 142 for expanding a movement path of the second audio.

In addition to an audio path for outputting audio, an electronic device may include a vent hole for connecting an interior of the electronic device and an exterior of the electronic device. In a case that audio from a speaker emitted through the vent hole is received by a microphone of the electronic device, noise may occur. The electronic device may need a structure capable of decreasing the audio from the speaker emitted through the vent hole.

An electronic device (e.g., the electronic device 100 of FIGS. 1A and 1B) is provided. According to an embodiment, the electronic device may include at least one speaker (e.g., the at least one speaker 130 of FIG. 1A) including a first surface (e.g., the first surface 130a of FIG. 1A), a second surface (e.g., the second surface 130b of FIG. 1A) opposite to the first surface, and a side surface (e.g., the side surface 130c of FIG. 1A) connecting the first surface and the second surface. According to an embodiment, the electronic device may include a housing (e.g., the housing 110 of FIG. 1A) configured to accommodate the at least one speaker, the housing including a first audio path (e.g., the first audio path 113a of FIG. 1A) extending from the first surface toward an exterior of the electronic device such that audio from the first surface is emitted to the exterior of the electronic device, and a vent hole (e.g., the vent hole 114 of FIG. 1A) separated from the first audio path. According to an embodiment, the electronic device may include a guide part (e.g., the guide part 142 of FIGS. 2B and 2C) extending along at least a portion of the side surface within the housing, the guide part including a first portion (e.g., the first portion 142a of FIGS. 2B and 2C) contacting the housing, and a second portion (e.g., the second portion 142b of FIG. 2C) spaced apart from the housing by a gap. According to an embodiment, the electronic device may include a second audio path (e.g., the second audio path 180 of FIGS. 2B and 2C) extending from the gap to the vent hole such that audio from the second surface passing through the gap is emitted to the vent hole. According to an embodiment, the second audio path may be located between the housing and an outer surface (e.g., the outer surface 142d of FIGS. 2B and 2C) of the guide part opposite to an inner surface (e.g., the inner surface 142C of FIGS. 2B and 2C) of the guide part facing at least a portion of the side surface.

The electronic device according to an embodiment may provide a structure capable of decreasing howling caused by the audio emitted through the vent hole by the guide part that relatively increases a movement path of the audio from the second surface to the vent hole.

According to an embodiment, the electronic device may include an electric component (e.g., the electric component 150 of FIG. 1A) disposed in the housing. According to an embodiment, the electronic device may include a flange part (e.g., the flange part 141 of FIG. 1A) disposed between the at least one speaker and the electric component by covering the second surface, the flange part connected to the guide part. According to an embodiment, the flange part may separate a first space in the housing in which the at least one speaker is disposed and a second space in the housing in which the electric component is disposed.

The electronic device according to an embodiment may provide a structure capable of saving a space in which components in the electronic device may be disposed while decreasing the howling caused by the audio emitted through the vent hole by the guide part connected to the flange part separating a space in which an electric component is disposed and a space in which the at least one speaker is disposed.

According to an embodiment, the housing may include a first case (e.g., the first case 111 of FIG. 1A) enclosing the at least one speaker and a portion of the flange part. According to an embodiment, the housing may include a second case (e.g., the second case 112 of FIG. 1A) enclosing the electric component and another portion of the flange part.

The electronic device according to an embodiment may provide a structure in which a space in which the components in the electronic device may be disposed is saved while decreasing the howling caused by the audio emitted through the vent hole by the guide part connected to the flange part that decreases electrical interference between the electric component and the at least one speaker.

According to an embodiment, the flange part may be integrally formed with the guide part.

The electronic device according to an embodiment may provide a structure in which a space in which the components in the electronic device may be disposed is saved while decreasing the howling caused by the audio emitted through the vent hole by the guide part, which is a portion of a bracket.

According to an embodiment, the vent hole is located near the first portion from among the first portion and the second portion.

The electronic device according to an embodiment may provide a structure capable of expanding the movement path of the audio from the second surface to the vent hole since the vent hole is disposed close to the first portion contacting the housing.

According to an embodiment, the electronic device may include a microphone (e.g., the at least one microphone 170 of FIG. 1A) disposed in the housing.

The electronic device according to an embodiment may provide a structure capable of decreasing a size of the audio emitted from the vent hole received by the microphone by the guide part that relatively increases the movement path of the audio from the second surface to the vent hole.

According to an embodiment, the vent hole may connect an interior of the housing and an exterior of the housing by penetrating a region of the housing corresponding to the side surface.

The electronic device according to an embodiment may provide a structure capable of decreasing discomfort of a user when the electronic device is worn by the user by the vent hole corresponding to the side surface of the at least one speaker.

According to an embodiment, the housing may include a nozzle part (e.g., the nozzle part 113 of FIG. 1A) surrounding the first audio path. According to an embodiment, the electronic device may include an ear tip (e.g., the ear tip 120 of FIG. 1A) detachably coupled to the nozzle part, the ear tip configured to contact an ear canal of a user when the electronic device is worn on an ear of the user.

The electronic device according to an embodiment may provide a structure capable of decreasing a pressure difference between an inside and an outside of the ear canal of the user by the vent hole corresponding to the side surface of the at least one speaker.

According to an embodiment, the vent hole may be located outside the ear canal when the electronic device is worn on the ear of the user.

The electronic device according to an embodiment may provide a structure capable of decreasing discomfort of the user since the vent hole is located outside the ear canal when the electronic device is worn on the ear of the user.

According to an embodiment, a frequency of the audio from the second surface may be lower than a frequency of the audio from the first surface.

According to an embodiment, the at least one speaker may include a first vibration plate (e.g., the first vibration plate 131 of FIG. 2B) configured to face the first surface. According to an embodiment, the at least one speaker may include a second vibration plate (e.g., the second vibration plate 132 of FIG. 2B) configured to face the second surface. According to an embodiment, the at least one speaker may include an enclosure (e.g., the enclosure 133 of FIG. 2B) surrounding the first vibration plate and the second vibration plate and forming the first surface, the second surface, and the side surface.

The electronic device according to an embodiment may provide various audios to the user by the first vibration plate and the second vibration plate that may operate independently of each other.

According to an embodiment, the enclosure may include at least one first hole (e.g., the at least one first hole of FIG. 2B) penetrating the first surface. According to an embodiment, the enclosure may include at least one second hole (e.g., the at least one second hole of FIG. 2B) penetrating the second surface.

According to an embodiment, the second portion may be spaced apart from the first portion along a circumferential direction of the housing.

According to an embodiment, the guide part may include an attachment surface (e.g., the attachment surface 143e of FIG. 2B) facing a direction in which the first surface faces, extending from the first portion to the second portion, and contacting the housing.

According to an embodiment, the guide part may be located between the at least one speaker and the vent hole when the housing is viewed along a direction in which the first surface faces.

An electronic device (e.g., the electronic device 100 of FIGS. 1A and 1B) is provided. According to an embodiment, the electronic device may include a housing (e.g., the housing 110 of FIG. 1A) including a vent hole (e.g., the vent hole 114 of FIG. 1A) and a nozzle part (e.g., the nozzle part 113 of FIG. 1A), the nozzle part inserted into an ear canal of a user when the electronic device is worn by the user. According to an embodiment, the electronic device may include at least one speaker (e.g., the at least one speaker 130 of FIG. 1A) including a first surface (e.g., the first surface 130a of FIG. 1A) facing the nozzle part, a second surface (e.g., the second surface 130b of FIG. 1A) opposite to the first surface, and a side surface (e.g., the side surface 130c of FIG. 1A) connecting the first surface and the second surface. According to an embodiment, the electronic device may include an electric component (e.g., the electric component 150 of FIG. 1A) disposed on the second surface and spaced apart from the at least one speaker. According to an embodiment, the electronic device may include a bracket (e.g., the first bracket 140 of FIG. 1A) including a flange part (e.g., the flange part 141 of FIG. 1A) disposed between the at least one speaker and the electric component, and a guide part (e.g., the guide part 142 of FIG. 1A) connecting to the flange part and extending along at least a portion of the side surface within the housing. According to an embodiment, the guide part may include a first portion (e.g., the first portion 142a of FIGS. 2B and 2C) contacting the housing. According to an embodiment, the guide part may include a second portion (e.g., the second portion 142b of FIG. 2C) spaced apart from the housing by a gap. According to an embodiment, audio from the second surface may be emitted to the vent hole by passing the gap along an audio path located between the housing and an outer surface of the guide part opposite to an inner surface of the guide part facing at least a portion of the side surface.

The electronic device according to an embodiment may provide a structure capable of decreasing howling caused by the audio emitted through the vent hole by the guide part that relatively increases a movement path of the audio from the second surface to the vent hole.

According to an embodiment, the housing may include a first case (e.g., the first case 111 of FIG. 1A) enclosing the at least one speaker and a portion of the flange part. According to an embodiment, the housing may include a second case (e.g., the second case 112 of FIG. 1A) enclosing the electric component and another portion of the flange part.

The electronic device according to an embodiment may provide a structure in which a space in which components in the electronic device may be disposed is saved while decreasing the howling caused by the audio emitted through the vent hole by the guide part connected to the flange part that decreases electrical interference between an electric component and the at least one speaker.

According to an embodiment, the vent hole may be located near the first portion from among the first portion and the second portion.

The electronic device according to an embodiment may provide a structure capable of expanding the movement path of the audio from the second surface to the vent hole since the vent hole is disposed close to the first portion contacting the housing.

According to an embodiment, the electronic device may include a microphone (e.g., the at least one microphone 170 of FIG. 1A) disposed in the housing.

The electronic device according to an embodiment may provide a structure capable of decreasing a size of the audio emitted from the vent hole received by the microphone by the guide part that relatively increases the movement path of the audio from the second surface to the vent hole.

According to an embodiment, the vent hole may connect an interior of the housing and an exterior of the housing by penetrating a region of the housing corresponding to the side surface.

According to an embodiment, the guide part overlaps the at least the portion of the side surface of the at least one speaker. The guide part does not overlap the first surface and the second surface of the at least one speaker.

According to an embodiment, a first distance between the vent hole and the first portion of the guide part is substantially a same distance as a second distance between the vent hole and the second portion of the guide part.

The electronic device according to an embodiment may provide a structure capable of decreasing discomfort of the user when the electronic device is worn by a user by the vent hole corresponding to the side surface of the at least one speaker.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
at least one speaker comprising:
a first surface,
a second surface opposite to the first surface, and
a side surface connecting the first surface and the second surface;
a housing accommodating the at least one speaker, the housing comprising:
a first audio path extending from the first surface toward an exterior of the electronic device such that audio from the first surface is emitted to the exterior of the electronic device, and
a vent hole separated from the first audio path;
a guide part extending along at least a portion of the side surface within the housing, the guide part comprising:
a first portion contacting the housing, and
a second portion spaced apart from the housing by a gap; and
a second audio path extending from the gap to the vent hole such that audio from the second surface passing through the gap is emitted to the vent hole,
wherein the second audio path is located between the housing and an outer surface of the guide part opposite to an inner surface of the guide part facing at least a portion of the side surface.

2. The electronic device of claim 1, further comprising:
an electric component disposed in the housing; and
a flange part disposed between the at least one speaker and the electric component by covering the second surface,
wherein the flange part is connected to the guide part, and
wherein the flange part separates a first space in the housing in which the at least one speaker is disposed and a second space in the housing in which the electric component is disposed.

3. The electronic device of claim 2, wherein the housing further comprises:
a first case enclosing the at least one speaker and a portion of the flange part; and
a second case enclosing the electric component and another portion of the flange part.

4. The electronic device of claim 2, wherein the flange part is integrally formed with the guide part.

5. The electronic device of claim 1, wherein the vent hole is located closer to the first portion from among the first portion and the second portion.

6. The electronic device of claim 1, further comprising:
a microphone disposed in the housing.

7. The electronic device of claim 1, wherein the vent hole connects an interior of the housing and an exterior of the housing by penetrating a region of the housing corresponding to the side surface.

8. The electronic device of claim 1,
wherein the housing further comprises:
a nozzle part surrounding the first audio path,
wherein the electronic device further comprises:
an ear tip detachably coupled to the nozzle part, and
wherein the ear tip is configured to contact an ear canal of a user when the electronic device is worn on an ear of the user.

9. The electronic device of claim 8, wherein the vent hole is located outside the ear canal when the electronic device is worn on the ear of the user.

10. The electronic device of claim 1, wherein a frequency of the audio from the second surface is lower than a frequency of the audio from the first surface.

11. The electronic device of claim 1, wherein the at least one speaker further comprises:
a first vibration plate facing the first surface;
a second vibration plate facing the second surface; and
an enclosure surrounding the first vibration plate and the second vibration plate and forming the first surface, the second surface, and the side surface.

12. The electronic device of claim 11, wherein the enclosure comprises:
at least one first hole penetrating the first surface; and
at least one second hole penetrating the second surface.

13. The electronic device of claim 11, wherein the second portion is spaced apart from the first portion along a circumferential direction of the housing.

14. The electronic device of claim 1,
wherein the guide part further comprises:
an attachment surface facing a direction in which the first surface faces,
wherein the attachment surface extends from the first portion to the second portion, and
wherein the attachment surface contacts the housing.

15. The electronic device of claim 1, wherein the guide part is located between the at least one speaker and the vent hole when the housing is viewed along a direction in which the first surface faces.

16. An electronic device comprising:
a housing comprising:
a vent hole, and
a nozzle part configured to be inserted into an ear canal of a user when the electronic device is worn by the user;
at least one speaker comprising:
a first surface facing the nozzle part,
a second surface opposite to the first surface, and
a side surface connecting the first surface and the second surface;
an electric component disposed on the second surface and spaced apart from the at least one speaker; and
a bracket comprising:
a flange part disposed between the at least one speaker and the electric component, and
a guide part connected to the flange part and extending along at least a portion of the side surface within the housing,
wherein the guide part comprises:
a first portion contacting the housing, and
a second portion spaced apart from the housing by a gap, and
wherein audio from the second surface is emitted to the vent hole by passing the gap along an audio path located between the housing and an outer surface of the guide part opposite to an inner surface of the guide part facing at least a portion of the side surface.

17. The electronic device of claim 16, wherein the housing further comprises:
a first case enclosing the at least one speaker and a portion of the flange part; and
a second case enclosing the electric component and another portion of the flange part.

18. The electronic device of claim 16, wherein the vent hole is located closer to the first portion from among the first portion and the second portion.

19. The electronic device of claim 16, further comprising:
a microphone disposed in the housing.

20. The electronic device of claim 16, wherein the vent hole connects an interior of the housing and an exterior of the housing by penetrating a region of the housing corresponding to the side surface.
